(19) United States
(12) Patent Application Publication
(10) Pub. No.: US 2003/0174299 A1
(43) Pub. Date: Sep. 18, 2003

(54) Method for producing images consisting of pixels

(75) Inventor: Ulrich Kluter, Munchen (DE)

Correspondence Address: DARBY & DARBY P.C., P. O. BOX 5257, NEW YORK, NY, 10150-5257, US

(73) Assignee: AGFA-GEVAERT AKTIENGESELLSCHAFT, Leverkusen (DE)

(21) Appl. No.: 10/382,314

(22) Filed: Mar. 5, 2003

(30) Foreign Application Priority Data
Mar. 12, 2002 (EP) 02005561.2

(51) Int. Cl. G03B 27/42

(52) U.S. Cl. 355/53

(57) ABSTRACT

A method of producing a pixel-based image on an image carrier (7), where a plurality of pixels are generated simultaneously by an array of pixel-generating elements, has the following steps:

producing on the image carrier a first partial image composed of first pixels, wherein each of the pixel-generating elements is assigned to produce one of the first pixels, and wherein the first pixels are spaced apart from each other, and

producing on the image carrier at least one further partial image composed of further pixels in such a manner that the further pixels fall into the spaces between the first pixels, but none of the further pixels is generated by a pixel-generating element that has produced one of the adjacent first pixels.

### BACKGROUND OF THE INVENTION

The invention relates to a method of producing images on an image carrier, wherein the images are composed of pixels (also referred to as image dots), a plurality of pixels are generated simultaneously by pixel-generating elements, and the image on the image-carrier is produced by the steps of:

producing on the image carrier at least one first partial image composed of first pixels, wherein each of the pixel-generating elements is assigned to produce one of the first pixels, and wherein the first pixels are spaced apart from each other, and

producing on the image carrier one or more further partial images, each composed of a further set of pixels, wherein each of the pixel-generating elements is assigned to produce one of the further pixels, and wherein the further partial images are laterally offset from the first partial image so that the further pixels fall into the spaces between the first pixels.

When producing an image of graphic information on a light-sensitive material, the aim is to maximize the detail resolution of the image. This is of particular importance in cases where the image-generating device is based on an electronic working principle. In electronic image-generating devices, the graphic information is generated as an assembly of individual pixels, where each pixel is represented by an individually controllable indicating element or elementary image component. However, image-generating devices based on this concept that are within a reasonable cost range have a resolution that is not adequate for producing images with a fine resolution at the quality level of photographs.

Thus, there is an incentive to find ways whereby an image that is produced on the light-sensitive material can have a higher level of resolution than, e.g., the LCD device that is used to generate the image. This can be accomplished with an image-generating apparatus that is designed so that the light-sensitive material is exposed more than once, with only a part of the surface of the light-sensitive material being exposed in each of the different exposures. This concept can be realized, e.g., with a mask that covers a part of each LCD element. The surface areas of the light-sensitive material that were not exposed in the exposure of a first partial image are exposed in the subsequent exposures of the remaining partial images. Based on this concept, each LCD element produces a plurality of image elements—each with different graphic information content—on different surface locations of the light-sensitive material. This process produces an image with complete coverage of the light-sensitive material surface in the image plane and with a resolution that is a multiple of the resolution of the LCD device.

The foregoing concept of increasing the resolution is applied in devices that produce an image of graphic information on a light-sensitive material such as photographic paper by means of a display device such as an LCD (liquid crystal device) or a DMD (digital mirror device) or another light-modulating device.

Each individual LCD element in an LCD device has a black border, i.e., the LCD elements are separated by a black matrix grid which causes an exposure gap in a sharp image produced on photographic paper. Thus, by offsetting the array of LCD elements to a position corresponding to the exposure gap and driving the LCDs with appropriate control signals, it is possible to fill the exposure gaps with the image information that would otherwise be missing from the image. With this concept, a complete image of high resolution can be generated from a plurality of partial images. The black matrix grid of the LCD device may cover, e.g., three fourths of the LCD surface. In this case, the active portion of each LCD element borders on a black area—vertically as well as horizontally with the same width as the active portion of the LCD element.

By assigning the data of an image of high resolution to four partial electronic images and using the concept of successive, staggered exposures of the four partial images, the resolution of the image on the photographic film can be quadrupled in relation to the resolution of the LCD device. The image data are assigned to the four partial images, e.g., in such a manner that all elements with even-numbered positions in the x-direction (0, 2, 4, . . . ) and even-numbered positions in the y-direction (0, 2, 4, . . . ) make up the first partial image, all elements with even-numbered positions in the x-direction (0, 2, 4, . . . ) and odd-numbered positions in the y-direction (1, 3, 5, . . . ) make up the second partial image, all elements with odd-numbered positions in the x-direction (1, 3, 5, . . . ) and even-numbered positions in the y-direction (0, 2, 4, . . . ) make up the third partial image, and all elements with odd-numbered positions in the x-direction (1, 3, 5, . . . ) and odd-numbered positions in the y-direction (1, 3, 5, . . . ) make up the fourth partial image. Thus, if the LCD device has, e.g., 1600×1200 elements, the photographically produced image will have 3200×2400 image dots.

A method of representing a digital image is known from EP 0 987 875, where in essence an LCD device is projected onto an image carrier by means of an objective lens. A rotatable glass plate is used to produce a lateral offset of the projected pixels in the image plane, and the image carrier is exposed either once or more than once for each position of the projected image.

Known LCD devices often exhibit so-called bright spots, i.e., faults in individual pixels that are mostly due to irregularities in the production process. The faulty LCD elements produce a flawed image in which the irregularities are particularly noticeable if they exceed a certain size. With the aforementioned state-of-the-art method, if an LCD element is defective, four images of it will be projected directly next to each other on the photo-sensitive material, resulting in a clearly visible defective macro pixel.

### OBJECT OF THE INVENTION

The present invention aims to provide a concept whereby the resolution of a pixel-based image on an image carrier can be increased through sequential exposures of partial images without the problem that a flaw caused by a defective pixel-generating element is amplified in the process.

### SUMMARY OF THE INVENTION

In the method according to the invention, a pixel-based image is produced on an image carrier by generating a plurality of pixels simultaneously. In a first step of the inventive method, a first partial image is produced on the image carrier, where the individual image dots of the first partial image are spaced apart from each other and each image dot is produced by a pixel-generating element specifically assigned to that image dot. The method has at least one further step, in which a further partial image is produced on the image carrier in such a manner that the image dots of the further partial image fall into the spaces between the image dots of the first partial image. According to the invention, each pixel of the further partial image is generated by a pixel-generating element that generated none of the neighboring pixels of the first partial image.

The inventive solution is based on the concept that the further partial image is laterally offset in the image plane by more than one pixel position in the optical projection, with a commensurate offset in the opposite direction being applied to the LCD elements through their electronic control. Two tiltable optical elements are arranged in series in the light path of the projection, with their tilt axes oriented at a right angle to each other, allowing the projected image of the LCD elements to be shifted in any direction on the photo-sensitive film. There are simple means of exactly delimiting the movement of the tiltable optical elements, so that the projection of the pixels onto a light-sensitive film is reproducible with a high degree of accuracy without the need to detect the position of the optical element prior to moving it.

Due to the fact that the projected images of the LCD elements can be shifted in any desired direction by any desired distance, the projection process can be controlled to minimize the visibility of a defective LCD element as much as possible. In the exposure process, the lateral shifting of the images of the LCD elements is therefore controlled in such a manner that the individual image dots produced by each LCD element are not adjacent to each other on the image carrier, but instead are spaced at a farther distance from each other. As a result, each LCD element produces a number of separate, small and spaced-apart image dots corresponding to the number of shift movements, where each individual dot is hardly visible to the naked eye.

In a particular embodiment of the invention, four partial images are generated so that the projected image dots produced by each individual LCD element form the corners of a rectangle. The distance between adjacent corners of the rectangle is equal to at least twice the corresponding dimension of an individual image dot.

The projected images of the LCD elements can also be shifted by different amounts in the x- and y-direction, i.e., the distance between the respective image dots of two partial images in a first direction can be different from the distance between the respective image dots in a second direction.

In colored images, each of the different partial images is projected onto the photo-sensitive material in all of the applicable colors. In the case of four partial images, each of the partial images is produced for each of the colors, such as blue, green and red. In order to make faulty LCD elements even less noticeable in the resulting image, one can select different amounts of pixel displacement between the partial images for the different colors. For example, the second partial image in red can be offset from the first partial image in red by a different amount than the second partial image in green is offset from the first partial image in green.

### BRIEF DESCRIPTION OF THE DRAWINGS

Further distinctive traits and advantages of the invention will be discussed in the following description of preferred embodiments that are illustrated in the drawings, wherein:

FIG. 1 represents an image-generating process according to the existing state of the art, and

FIG. 2 represents an image-generating process according to an embodiment of the invention.

### DETAILED DESCRIPTION OF PREFERRED EMBODIMENTS

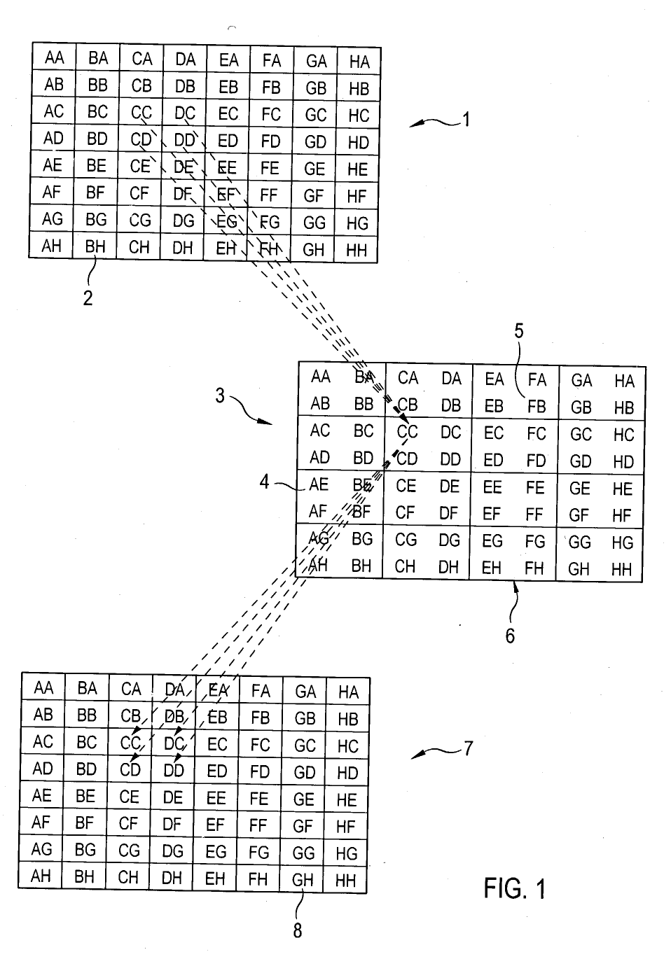

FIG. 1 gives a schematic illustration of the process of assembling a pixel-based reproduction of an image stored with high resolution in a memory device by using an LCD device of lesser resolution according to the existing state of the art.

FIG. 1 shows a memory array or memory plane 1 containing the image data in a high-resolution format. The plane 1 has a large number of memory cells 2. The information in the memory cells 2 is used to drive an LCD device 3. More specifically, each memory cell 2 controls one of the large number of LCD elements 6 that make up the LCD array 3. In the illustrated embodiment, as the partial images are formed one after the other, only a fourth of the image data of the image plane 1 are represented at one time by the LCD panel 3. The information of each pixel is identified by a pair of letters, with the first letter denoting the column and the second letter denoting the row of the matrix array. A first partial image is composed of all pixels identified by a first letter A, C, E, or G combined with a second letter A, C, E, or G. The second partial image is made up of the pixels with a first letter B, D, F, or H combined with a second letter A, C, E, or G. The third partial image is composed of all pixels identified by a first letter B, D, F, or H combined with a second letter B, D, F, or H. The fourth partial image is composed of all pixels identified by a first letter A, C, E, or G combined with a second letter B, D, F, or H.

Using a light source and a projection device (not illustrated), the partial image represented by the LCD device 3 is projected onto light-sensitive paper. The LCD elements 6 of the LCD device 3 have three fourths of their surface area covered by a black matrix 5, which causes an exposure gap in the image on the photo-sensitive paper. The active one-fourth of the surface of each LCD element 6 is identified by the reference symbol 4.

In order to sequentially produce the partial images in the image plane in such a manner that the partial images are not exposed on top of each other in the same place, the projection device is equipped with an optical element that moves the projected image selectively by the amount of the width and/or the height of one image dot 8 of the projected image 7. The displacement of the projected partial image occurs in the vertical and/or horizontal direction depending on which of the partial images is being projected. In order to illustrate the concept of the sequentially generated partial images, each individual LCD element 6 in the LCD device 3 is shown with all of the address data of the memory cells 2 that are processed through that specific LCD element.

The projected image 7 is composed of individual image dots 8. Each image dot 8 is named according to the address of the memory cell 2 with which the image dot 8 is correlated.

If one of the LCD elements 6 of the LCD device 3 is defective, this will cause a fault in all of the image dots produced by the defective LCD element. Accordingly, with the prior-art method shown in FIG. 1, a defective LCD element will cause a large gap in the projected image 7. For example, with a failure of the LCD element in the second column and the second row of the LCD device 3, which has the image data CC, DC, DD and CD assigned to it, the projected image 7 will have an image gap in the place assigned to the image dots CC, DC, DD and CD. As a result, the image will have a flaw that is clearly visible to the viewer.

To avoid the problem that a defective LCD element causes this kind of flaw in the projected image 7, the present invention proposes to modify the prior-art method in such a manner that for each image dot in the projected image 7, the LCD element producing that image dot is not the same element that produced any of the neighboring image dots.

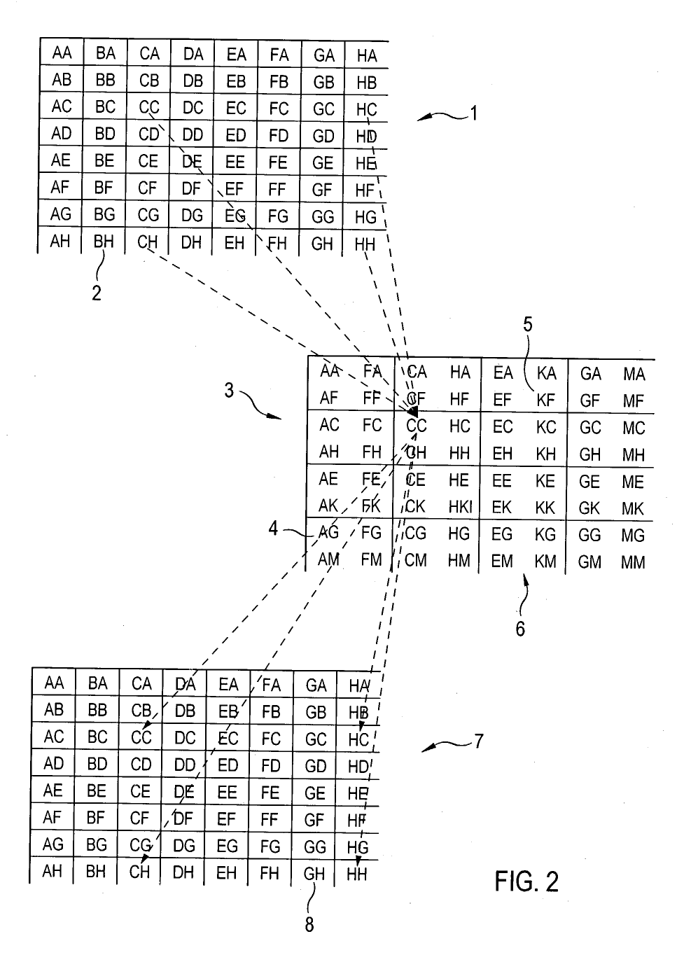

To visualize the inventive method, FIG. 2 shows again a part of a memory plane 1 with memory cells 2 containing the image date of an image. The addresses of the memory cells are structured in the same manner as in the memory plane of FIG. 1.

Analogous to the memory plane 1, only a representative portion of the LCD device 3 is shown. FIG. 2 again shows the black matrix 5 and the active quarter section 4 as well as the memory addresses of the image dots that are processed by each of the LCD elements 6.

Under the preferred concept, the image information is again divided into four partial images. The first partial image is produced from the image data whose addresses are formed by any pair of the letters A, C, E, G. The second partial image uses image data formed by pairs in which the first letter is F, H, K, or M and the second letter is A, C, E, or G. The third partial image uses data formed by pairs in which the first as well as the second letter is one of the letters F, H, K, M. The fourth partial image uses image data formed by pairs in which the first letter is A, C, E, or G and the second letter is F, H, K, or M.

The exposure for the first partial image is carried out in the same manner as in the example of FIG. 1. In the exposure of the second partial image, however, the projection of the partial image onto the image plane is moved horizontally by an amount equal to the width of five image dots 8 rather than one image dot. The displacement has to be by an odd number of image dots.

The same concept applies to the exposure of the third partial image. In this case, the displacement is in the vertical direction. In the illustrated example, the projection is displaced likewise by five times the height of an image dot. However, the vertical displacement could also be a different odd multiple of the height of an image dot. The horizontal and vertical displacements don't need to be by the same number of pixels. The fourth partial image is projected with a horizontal displacement by the same amount but in the opposite direction of the displacement for the second partial image.

The individual partial images are projected in sequence, so that the result is a series of exposures that add up to the combined image 7. In the exposure of each partial image, the shifts in the image data between the memory cells 2 of the memory plane 1 and the LCD elements 6 of the LCD device 3 are compensated by the displacements of the projection, so that the image produced in the image plane corresponds exactly to the image stored in the memory plane 1, i.e., the sequence and arrangement of the image dots 8 corresponds exactly to the image data stored in the memory cells 2 of the memory plane 1.

To illustrate the effect of a faulty LCD element in the example of FIG. 2, the element in the second column on the second line is again assumed to be defective. This element would normally serve to process the image data at the addresses CC, HC, HH, and CH. Since the arrangement of the memory cells corresponds to the arrangement of the resulting pixel dots in the exposed image 7, the black (faulty) image dots CC, HC, HH, and CH are not contiguous to each other but are spaced apart from each other. For example, the faulty pixel dot CC lies five columns to the left of the faulty pixel dot HC, five lines above the faulty pixel dot CH, and five lines above as well as five columns to the left of the faulty pixel dot HH.

As a result, the image flaw caused by the faulty LCD element is distributed over four small pixel dots which are less distracting to the eye of the viewer than the image flaw that would be caused by the same faulty LCD element under the state-of-the-art method as illustrated in FIG. 1.

The invention is not limited to the embodiment described above. While the foregoing description with the accompanying FIGS. 1 and 2 refers to an example where the image data of four memory cells 2 are represented through one LCD element 6, it is self-evident that one could also represent the image data of six, eight, nine, twelve, or sixteen memory cells 2 through one LCD element 6. In these cases there would be, respectively, six, eight, nine, twelve, or sixteen partial images generated instead of the four partial images discussed above. According to the inventive concept, the spacing between pixels 8 that are generated by one LCD element is always selected in such a manner that the image pixels generated by a faulty LCD element will not be seen by the viewer as one contiguous image pixel.

The displacement of the individual partial images can also be made color-specific. For example in the red separation, the four partial images could be displaced by 5 image dots, in the green separation by 7 image dots, and in the blue separation by nine image dots. A defective LCD element would in this case be projected to a different spot in each color separation and would thus be even less noticeable to the eye of the viewer.

The individual color separations can be generated in a known manner either by way of a white light source with suitable color filters, or by way of colored light sources such as, e.g., LEDs (light-emitting diodes).

What is claimed is:

1. A method of producing an image on an image carrier, wherein the image is composed of pixels and a plurality of pixels are generated simultaneously by pixel-generating elements, the method comprising the steps of:
producing on the image carrier at least one first partial image composed of first pixels, wherein each of the first pixels has one of the pixel-generating elements assigned to produce said first pixel, and wherein the first pixels are spaced apart from each other, and
producing on the image carrier at least one further partial image composed of further pixels, wherein each of the further pixels has one of the pixel-generating elements assigned to produce said further pixel, wherein the further pixels fall into the spaces between the first pixels, and wherein each further pixel is generated by a pixel-generating element that has generated none of the first pixels bordering on said further pixel.

2. The method of claim 1, wherein the step of producing on the image carrier at least one further partial image composed of further pixels comprises:
producing on the image carrier at least one second partial image composed of second pixels,
producing on the image carrier at least one third partial image composed of third pixels, and
producing on the image carrier at least one fourth partial image composed of fourth pixels.

3. The method of claim 2, wherein the image-generating elements are arranged in a grid of rows and columns, wherein producing said partial images comprises sequentially projecting said grid onto the image carrier for four separate exposures, and wherein each of said exposures is displaced relative to any of the other exposures by at least one of a horizontal offset and a vertical offset, said horizontal offset being at least three columns and said vertical offset being at least three rows.

4. The method of claim 3, wherein the number of columns in the horizontal offset is different from the number of rows in the vertical offset.

5. The method of claim 1, wherein the image-generating elements are arranged in a grid of rows and columns, wherein producing said partial images comprises sequentially projecting said grid onto the image carrier for a plurality of exposures, wherein each of said exposures is displaced relative to any of the other exposures by at least one of a horizontal offset and a vertical offset, said horizontal offset being a plural number of columns and said vertical offset being a plural number of rows, wherein separate sets of exposures are made for different colors, and wherein said horizontal and vertical offsets between any two exposures depend on which of said different colors said two exposures belong to.
